(19) United States
(12) Patent Application Publication
(10) Pub. No.: US 2007/0113439 A1
(43) Pub. Date: May 24, 2007

(54) Markable and erasable banner

(76) Inventor: Frank Guidice, Glen Head, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/284,262

(22) Filed: Nov. 21, 2005

(51) Int. Cl. G09F 11/18

(52) U.S. Cl. 40/517

(57) ABSTRACT

A banner display device is disclosed which includes a flexible material; a roller, with the roller rollingly engaging the flexible material for storage thereon; and at least one marking or erasing utensil. The marking and erasing utensils are disposed in a storage area in the vicinity of the roller, with the marking utensil capable of marking a surface of the flexible material.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 is a front view of one embodiment of a banner according to the present disclosure;

FIG. 2 is a partial perspective view of the banner according to FIG. 1;

FIG. 3 is a partial perspective view of a variation of the embodiment of the banner illustrated in FIG. 1;

FIG. 4 is a perspective view of another variation of the embodiment of the banner illustrated in FIG. 1;

FIG. 5 is a perspective view of another embodiment of a banner according to the present disclosure;

FIG. 6 is a perspective view of yet another embodiment of a banner according to the present disclosure; and

FIG. 7 is a partial perspective view of yet another embodiment of a banner according to the present disclosure.

### DETAILED DESCRIPTION

The present disclosure will be understood more fully from the detailed description given below and from the accompanying drawings of particular embodiments of the invention which, however, should not be taken to limit the invention to a specific embodiment but are for explanatory purposes.

Numerous specific details may be set forth herein to provide a thorough understanding of a number of possible embodiments of a combination handle and rotating tool extension incorporating the present disclosure. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments disclosed herein are not necessarily limited in this context.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

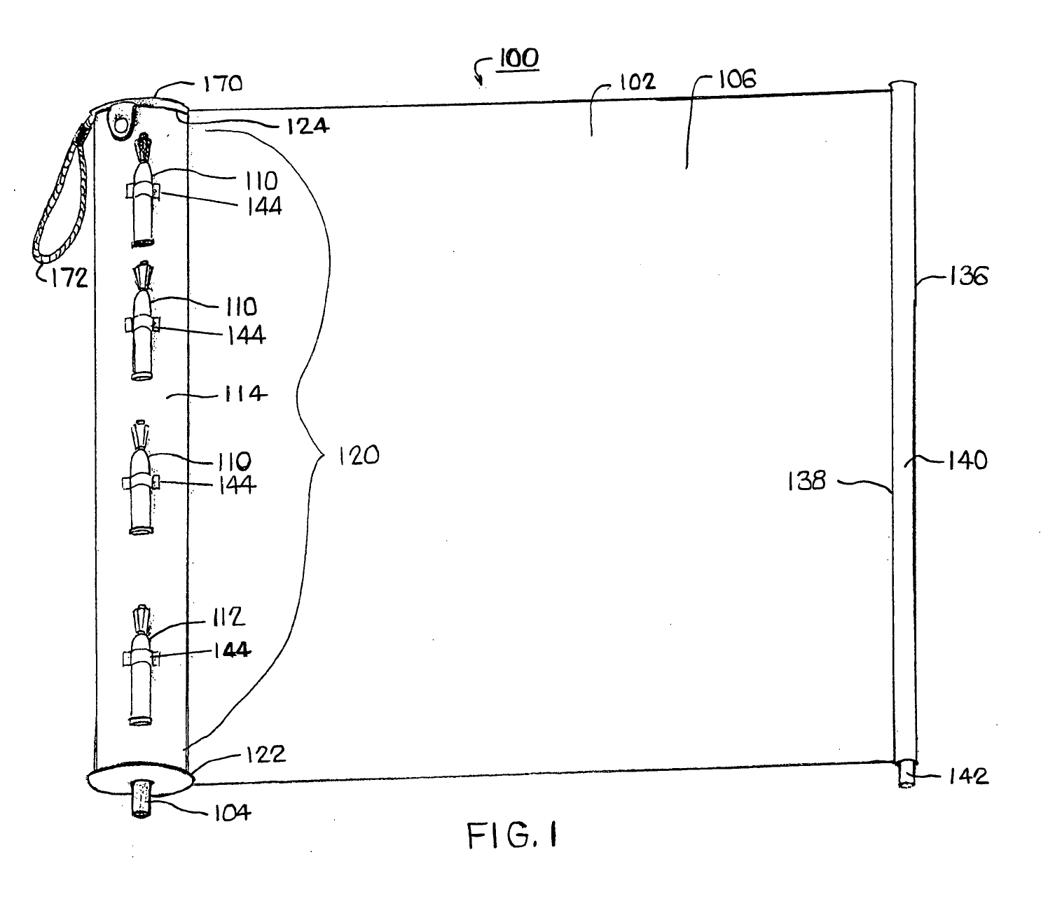

Turning now to the details of the present disclosure, FIGS. 1-6 disclose a banner display device 100 which can be easily written upon and erased or distributed at a public event. More particularly, FIG. 1 discloses banner display device 100 including a flexible material 102 including a markable surface 106. The banner display device 100 further includes a roller 104, wherein the roller 104 rollingly engages the flexible material 102 for storage thereon; and at least one marking utensil 110. The at least one marking utensil 110 is disposed in a storage area 120 in the vicinity of the roller 104, with the marking utensil 110 being capable of marking the surface 106 of the flexible material 102. The storage area 120 may include at least one erasing utensil 112 capable of erasing the surface 106 of the flexible material after marking by the at least one marking utensil 110.

The flexible material 102 is made typically from, and is not limited to, soft and hard plastics, nylon, fabrics, and rubber. The roller is made typically from, and is not limited to, a plastic, metal such as aluminum or wood.

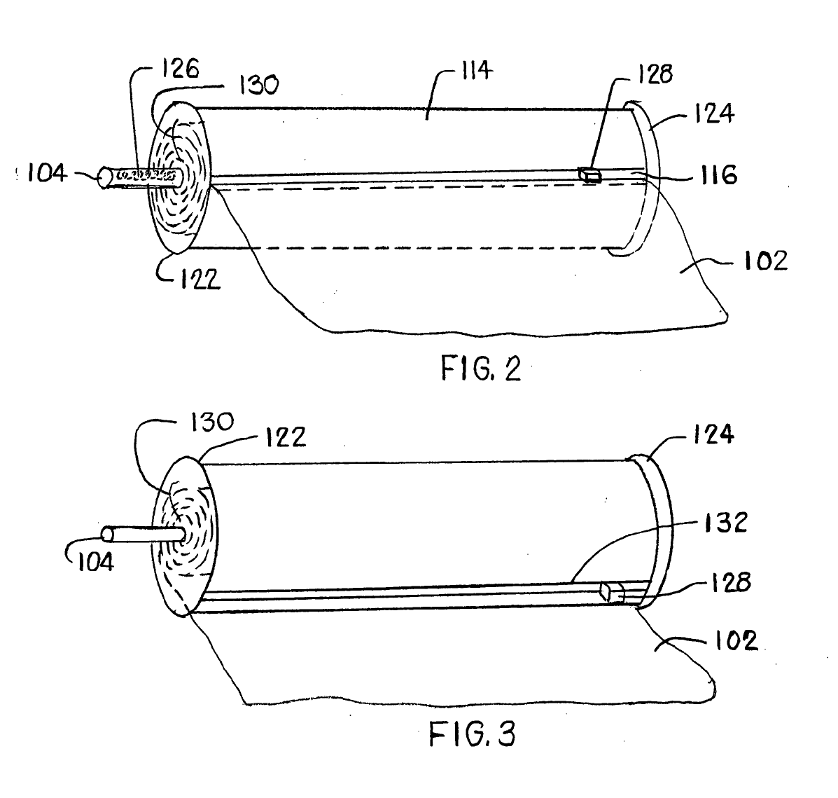

As best shown in FIG. 2, in one embodiment, the banner display device 100 further includes a roller housing 114 at least partially housing the roller 104 and the flexible material 102. The roller 104 is configured to extend and retract the flexible material 102 from within the roller housing 114 through a slot or aperture 116 disposed therethrough.

The roller 104 includes a first end plate 122 and a second end plate 124. The roller housing 114 is coupled to the first and second end plates 122 and 124 so that the roller housing 114 and the first and second end plates 122 and 124 at least partially house the flexible material 102 stored on the roller 104 (until the flexible material 102 is depleted) in the form of a roll 130. The slot or aperture 116 extends typically from the first end plate 122 to the second end plate 124. The roller 104 may include an internal spring return mechanism 126 for extending and retracting the flexible material 102 through the aperture 116 in the roller housing 114.

The banner display device 100 may include the roller housing 114 having a separator 128 for separating a portion of the flexible material 102. More particularly, the separator 128 may be, for example and is not limited to, a slidable knife assembly which is configured to slide along the aperture 116 to slice a portion of the flexible material 102.

Referring to FIG. 3, the banner display device 100 may include the roller 104 and first and second roller end plates 122 and 124, respectively, wherein the separator 128 may be, for example and is not limited to, the slidable knife assembly which is configured to slide along a rail 132, which extends at least partially from the first end plate 122 to the second end plate 124. The embodiments are not limited in this context.

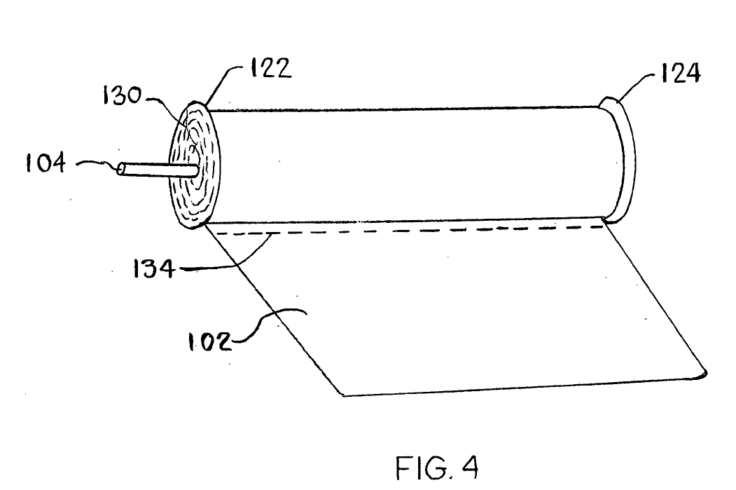

As illustrated in FIG. 4, in one embodiment, the banner display device 100 includes the flexible material 102 being configured with perforations 134 for separating a portion of the flexible material 102 from the roll 130. The user of the banner display device 100 exerts a force on the flexible material 102 to overstress the flexible material 102 at the perforations 134 so as to separate a portion of the flexible material 102 from the roll 130.

Referring back to FIG. 1, in one embodiment of the banner display device 100, the storage area 120 is disposed on an external surface 134 of the roller housing 114. More particularly, at least one marking utensil 110 and typically at least one erasing utensil 112 are disposed on the external surface via a fastening mechanism such as straps 144. The flexible material 102 may further include a leader loop 140 at a leading edge 136 of the material 102. The leader loop 140 is formed around a leader post 142 and may be joined back via a seam 138. The roller housing 114 may include a roller housing end cover 170 coupled to second end plate 124. The roller housing end cover 170 may include a manipulating means such as strap 172 fastened thereto.

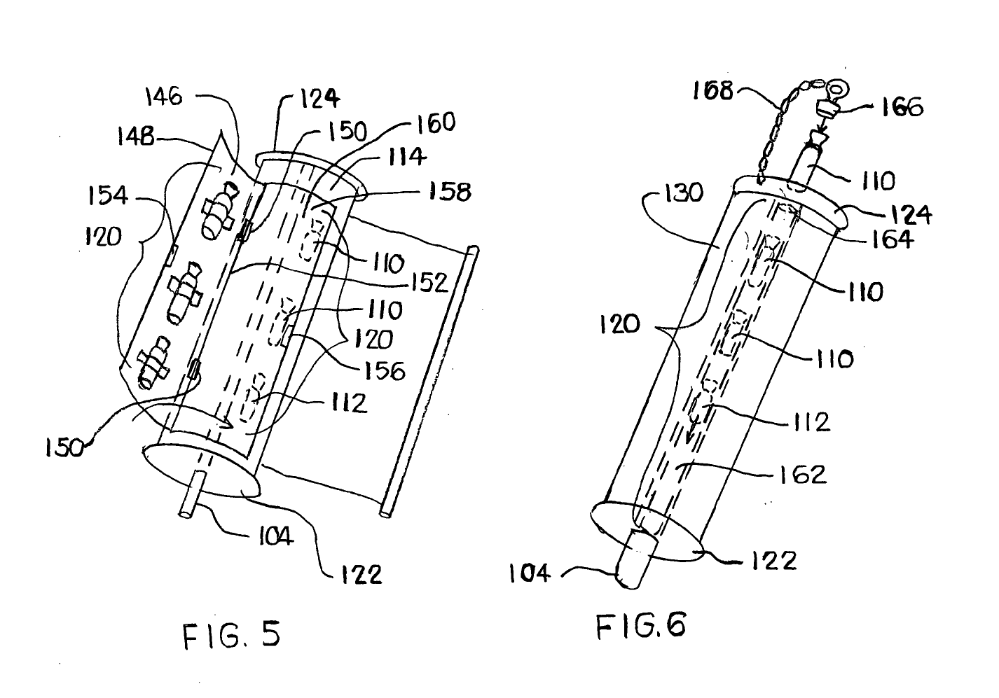

Referring to FIG. 5, in one embodiment of the banner display device 100, the storage area 120 is disposed on an internal surface 146 of the roller housing 114. More particularly, a door 148 is disposed within the housing 114 and is configured to expose the internal surface 146 upon opening. The door 148 is coupled to the roller housing 114 via hinges 150 disposed on an edge 152 of the door 148. The door 148 may further include a lock tab 154 which engages with a lock mechanism 156 disposed on the roller housing 114.

When in the open position, the door 148 exposes an aperture 158 of an internal compartment 160 within the roller housing 114. In one embodiment, the storage area 120 is disposed in the interior compartment 160 of the roller housing 114.

Referring to FIG. 6, in one embodiment of the banner display device 100, the storage area 120 is disposed in an interior compartment 162 formed in the roller 104. The marking utensils 110 and erasing utensils 112 may be inserted into the interior compartment 162 through an aperture 164 formed at one of end plates 122 and 124, such as at second end plate 124, the aperture 164 communicating with the interior compartment 162. The marking utensils 110 and erasing utensils 112 may be sealed within the interior compartment 162 via a sealing means such as a plug 166 which sealingly engages with the aperture 164. The plug 166 may be fastened to the second end plate 124 via a fastening means such as chain 168 coupled therebetween.

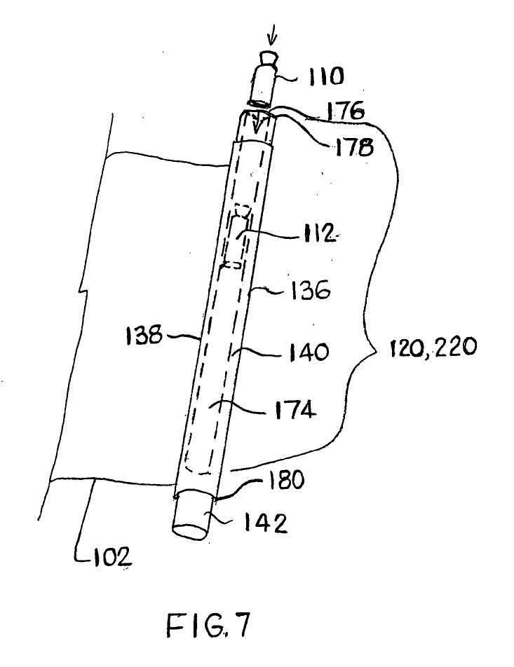

Referring to FIG. 7, in one embodiment of the banner display device 100 of FIG. 1, as previously discussed, the flexible material 102 has a leading edge 136 which may include a seam 138 forming a leader loop 140. The leader loop 140 may have a post 142 disposed therein. The post 142 includes first and second ends 178 and 180, respectively.

In one embodiment, the storage area 120 is disposed in an interior compartment 174 formed within the post 142. The marking utensils 110 and the erasing utensils 112 may be inserted into the interior compartment 174 through an aperture 176 formed at one of first and second ends 178 and 180. The aperture 176 may be sealed via a sealing means such as plug 166 which sealingly engages with the aperture 176. The plug 166 may be fastened to the second end 180 via a fastening means such as chain 168 coupled therebetween (see FIG. 6).

Alternatively, a second storage area 220 is disposed in an interior compartment 174 formed within the post 142. The marking utensils 110 and the erasing utensils 112 may be inserted into the interior compartment 174 through an aperture 176 formed at one of first and second ends 178 and 180. The aperture 176 may be sealed via a sealing means such as plug 166 which sealingly engages with the aperture 176. The plug 166 may be fastened to the second end 180 via a fastening means such as chain 168 coupled therebetween (see FIG. 6). One of ordinary skill in the art will recognize that storage area 220 is identical to storage area 120 described above.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments. Those skilled in the art will envision other modifications within the scope and spirit of the claims appended hereto.

What is claimed is:

1. A banner display device comprising:
a flexible material;
a roller, the roller rollingly engaging the flexible material for storage thereon; and
at least one marking utensil, the at least one marking utensil disposed in a storage area in the vicinity of the roller, the marking utensil capable of marking a surface of the flexible material.

2. The banner display device according to claim 1, further comprising:
a roller housing at least partially housing the roller and the flexible material; and
wherein the roller is configured to extend and retract the flexible material from within the roller housing through an aperture disposed therethrough.

3. The banner display device according to claim 2, wherein the roller includes an internal spring return mechanism for extending and retracting the flexible material through the aperture in the roller housing.

4. The banner display device according to claim 1, further comprising:
a roller housing at least partially housing the roller; wherein the roller is configured to extend the flexible material, the roller housing having a separator for separating a portion of the flexible material.

5. The banner display device according to claim 1, wherein the flexible material is configured with perforations for separating a portion of the flexible material.

6. The banner display device according to claim 1, further comprising a roller housing at least partially housing the roller, and wherein the storage area is disposed on an external surface of the roller housing.

7. The banner display device according to claim 1, further comprising a roller housing at least partially housing the roller, wherein the storage area is disposed on an internal surface of the roller housing.

8. The banner display device according to claim 7, wherein a door is disposed within the housing and configured to expose the internal surface upon opening.

9. The banner display device according to claim 1, further comprising a roller housing at least partially housing the roller, wherein the storage area is disposed in an interior compartment of the roller housing.

10. The banner display device according to claim 1, wherein the storage area is disposed in an interior compartment of the roller.

11. The banner display device according to claim 1, wherein the flexible material comprises a seam forming a leader loop, the leader loop having a post disposed therewithin, and the storage area is disposed in an interior compartment formed within the post.

12. The banner display device according to claim 1, further comprising at least one erasing utensil in the storage area, the erasing utensil capable of erasing the surface of the flexible material after marking by the marking utensil.

13. A banner display device comprising:
a flexible material;
a roller, the roller rollingly engaging the flexible material for storage thereon;
a roller housing at least partially housing the roller and the flexible material, wherein the roller is configured to extend and retract the flexible material from within the roller housing through an aperture disposed therethrough; and
at least one marking utensil, the at least one marking utensil disposed in a storage area in the vicinity of the roller, the marking utensil capable of marking a surface of the flexible material, the storage area being disposed on an external surface of the roller housing.

14. The banner display device according to claim 13, wherein the roller includes an internal spring return mechanism for extending and retracting the flexible material through the aperture in the roller housing.

15. The banner display device according to claim 13, wherein the roller housing comprises a separator for separating a portion of the flexible material.

16. The banner display device according to claim 13, wherein the flexible material comprises a seam forming a leader loop, the leader loop having a post disposed therewithin, and the storage area is disposed in an interior compartment formed within the post.

17. The banner display device according to claim 13, further comprising at least one erasing utensil in the storage area, the erasing utensil capable of erasing the surface of the flexible material after marking by the marking utensil.

18. A banner display device comprising:
a flexible material;
a roller, the roller rollingly engaging the flexible material for storage thereon;
a roller housing at least partially housing the roller and the flexible material, wherein the roller is configured to extend and retract the flexible material from within the roller housing through an aperture disposed therethrough; and
at least one marking utensil, the at least one marking utensil disposed in a storage area in the vicinity of the roller, the marking utensil capable of marking a surface of the flexible material, the storage area being disposed on an internal surface of the roller housing.

19. The banner display device according to claim 18, wherein the storage area is disposed in an interior compartment of the roller housing.

20. The banner display device according to claim 1, wherein the flexible material comprises a seam forming a leader loop, the leader loop having a post disposed therewithin, and a second storage area is disposed in an interior compartment formed within the post.
